(19) United States
(12) Patent Application Publication
(10) Pub. No.: US 2020/0148810 A1
(43) Pub. Date: May 14, 2020

(54) ADDITIVE COMPOSITION AND METHOD

(71) Applicant: Dow Global Technologies LLC, Midland, MI (US)

(72) Inventors: Min Zhao, Audubon, PA (US); Liang Chen, Sewickley, PA (US); Xue Chen, Manvel, TX (US)

(21) Appl. No.: 16/632,043

(22) PCT Filed: Jul. 10, 2018
(86) PCT No.: PCT/US2018/041366

§ 371 Date: Jan. 17, 2020

Related U.S. Application Data
(60) Provisional application No. 62/539,177, filed on Jul. 31, 2017.

(51) Int. Cl. C08G 18/76; C08G 18/75; C08G 18/73; C08G 18/32; C08J 3/215; C08J 3/12

(52) U.S. Cl. CPC C08G 18/7614; C08G 18/7664; C08G 18/755; C08J 3/122; C08G 18/3228; C08J 3/215; C08G 18/73

(57) ABSTRACT

An additive comprising an active; the interfacial polymerization reaction product of a (poly)isocyanate and a polyamine; a copolymer having maleic anhydride-based repeat units and either or both of olefinic or styrenic-based repeat units; wherein at least a portion of the maleic anhydride-based repeat units are neutralized. A method of preparing an additive comprising providing an oil phase comprising an active, a solvent, a (poly)isocyanate; providing an aqueous phase comprising water and an emulsifier; mixing the oil phase and the aqueous phase to provide an emulsion; providing a polyamine to the emulsion; providing an aqueous dispersion or solution comprising a copolymer having maleic anhydride-based repeat units and either or both of olefinic or styrenic-based repeat units; wherein at least a portion of the maleic anhydride-based repeat units are neutralized; and cofeeding the emulsion and the aqueous dispersion or solution to a spray dryer.

### BACKGROUND

There are many applications where encapsulating an active is desirable. For example, textiles, such as wearable fabrics, are typically washed by contacting the textiles with a detergent formulation that is a combination of detergent components and other optional actives, such as bleaching agents. For ease of use, many detergent formulation users prefer an all-in-one product that incorporates the detergents and optional actives into a single product. Further, many users prefer this product to be a liquid, as compared to a solid or granular product.

One common detergent active is tetraacetylethylenediamine (TAED). TAED functions as a peroxy bleaching activator and a microbial control agent. TAED has been extensively used in solid detergent products. TAED, in liquid detergent formulations which contain in part water, will undergo hydrolysis and lose effectiveness as a detergent active as the TAED reacts to form N, N′ diacetylethylenediamine (DAED), which is not effective as a detergent active. As such, TAED, when used without modification, is not ideal as an active for an aqueous detergent formulation. Triacetylethylenediamine (TriAED) is another detergent active. An additive containing active that is suitable for use in formulations that contain water is desired.

### SUMMARY OF THE INVENTION

An additive comprising an active; the interfacial polymerization reaction product of a (poly)isocyanate and a polyamine; and a copolymer having maleic anhydride-based repeat units and either or both of olefinic or styrenic-based repeat units; and wherein at least a portion of the maleic anhydride-based repeat units are neutralized.

A method of preparing an additive comprising providing an oil phase comprising an active, a solvent, a (poly)isocyanate; providing an aqueous phase comprising water and an emulsifier; mixing the oil phase and the aqueous phase to provide an emulsion; providing a polyamine to the emulsion; providing an aqueous dispersion or solution comprising a copolymer having maleic anhydride-based repeat units and either or both of olefinic or styrenic-based repeat units; wherein at least a portion of the maleic anhydride-based repeat units are neutralized; and cofeeding the emulsion and the aqueous dispersion or solution to a spray dryer.

### DETAILED DESCRIPTION OF THE INVENTION

The present disclosure describes an improved additive for encapsulating an active. In one aspect, the present disclosure describes an additive comprising an active, for example, tetraacetylethylenediamine (TAED), the interfacial polymerization reaction product of a (poly)isocyanate and a polyamine, and a copolymer having maleic anhydride-based repeat units and either or both of olefinic or styrenic-based repeat units wherein at least a portion of the maleic anhydride-based repeat units are neutralized. The improvement of the additive described herein is increased hydrolytic stability for the active which gives enhanced long-term stability in an aqueous formulation. As used herein, “(poly)”isocyanate refers to either or both of a polymeric isocyanate or a monomeric isocyanate.

The (poly)isocyanate is selected from the group consisting of toluene diisocyanate, 4,4′-diphenylmethane diisocyanate, polymethylene polyphenyl isocyanate, isophorone diisocyanate, 1,4-diisocyanatobutane, 1, 4-phenylene diisocyanate, 1,3-phenylene diisocyanate, hexamethylene diisocyanate, 1,3-bis(isocyanatomethyl)benzene, 1,8-diisocyanatooctane, 4-4′-methylenebis(phenyl isocyanate), and 4,4′methylenebis(cyclohexyl isocyanate).

The polyamine is a water-soluble polyamine. The water-soluble polyamine is selected from the group consisting of ethylenediamine, diethylenetriamine, triethylenetretraamine, tetraethylenepentamine, and pentaethylenehexamine.

The (poly)isocyanate and the polyamine are reacted together in an interfacial polymerization reaction. The interfacial polymerization reaction involves a polymerization reaction at the interface between two phases, here an oil phase and an aqueous phase. The oil phase includes the active, the (poly)isocyanate and a solvent. The aqueous phase includes water and an emulsifier. The emulsifier is a nonionic surfactant. The non-ionic surfactant may be a polymeric surfactant of block or random copolymers. Nonionic surfactants include ethoxylated aliphatic or aromatic alcohols, castor-oil based ethoxylates, fatty acid ethoxylates, polyoxyethylene-polyoxypropylene block or random copolymers, sorbitan ester ethoxylates, polyethyleneglycol esters, and polyoxyethylene fatty acid amides. Preferred surfactants are Croda's polymeric surfactants and dispersants available under the Atlas and Atlox, tradename. Most preferred is Atlox 4914 a random copolymer of an alkyd-PEG resin. The oil phase and the water phase are mixed to form an emulsion. The polyamine is added to the emulsion, wherein the polyamine and the (poly)isocyanate react via interfacial polymerization.

The solvent is selected from the groups of petroleum fractions or hydrocarbons such as mineral oil, aromatic solvents, xylene, toluene, paraffinic oils, and the like; vegetable oils such as soy bean oil, rape seed oil, olive oil, castor oil, sunflower seed oil, coconut oil, corn oil, cotton seed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, ethylhexyl benzoate, isopropyl benzoate, n-butyl oleate, isopropyl myristate, propylene glycol dioleate, di-octyl succinate, di-butyl adipate, di-octyl phthalate, acetyl tributyl citrate, triethylcitrate, triethyl phosphate, and the like; esters of mono, di and polycarboxylic acids, such as benzylacetate, ethylacetate, and the like; ketones, such as cyclohexanone, acetophenone, 2-heptanone, gamma-butyrolactone, isophorone, amides, such as N-ethyl pyrrolidone, N-octyl pyrrolidone, and the like; alkyldimethylamides, such as dimethylamide of C8 and C10 acids, dimethylacetamide, and the like; alcohols of low water solubility such as benzyl alcohol, cresols, terpineols, tetrahydrofurfurylalcohol, 2-isopropylphenol, cyclohexanol, n-hexanol, and the like. Examples of solvents useful in the present application are Solvesso™ aromatic fluids available from ExxonMobil.

A variety of linear and branched chain alpha-olefins are suitable for use as the olefinic-based repeat units of the copolymer. Particularly useful alpha-olefins are 1-alkenes containing 4 to 14 carbon atoms, preferably 3 to 12 carbon atoms, such as isobutylene, 1-butene, 1-hexene, 1-octene, 1-decene and 1-dodecene, with isobutylene and 1-octene being preferred. A part of the alpha-olefins can be replaced by other monomers, with isobutylene being most preferred.

Copolymers of maleic anhydride and styrene are commercially available and suitable for use in the methods and compositions of the present disclosure. For example, Maleic Anhydride Styrene Copolymers from Lubrizol company.

Copolymers of maleic anhydride and olefin are commercially available and suitable for use in the methods and compositions of the present disclosure. For example, ISOBAM brand maleic anhydride copolymers are available from Kuraray Co. (Japan) or ACUSOL™ 460ND available from The Dow Chemical Company.

The weight average molecular weight of the copolymer is preferably 1,000 to 10,000,000. The weight average molecular weight of the copolymer is more preferably 50,000 to 500,000. Preferably, the maleic anhydride-based repeat units comprise from 40 to 60 mole % of the copolymer, more preferably from 45 to 55 mole %, and more preferably from 48 to 52 mole %.

At least a portion of the maleic anhydride-based repeat units of the copolymer are neutralized. Neutralization is measured as a mole percent of acid functionalities of the maleic anhydride-based repeat units which have been neutralized. Preferably 30 to 60 mole percent of the acid functionalities of the maleic anhydride-based repeat units of the copolymer are neutralized.

The maleic anhydride-based repeat units are neutralized with a neutralization agent. Preferably, the neutralization agent is sodium hydroxide, potassium hydroxide, ammonium hydroxide, monoethanolamine, diethanolamine, triethanolamine, aminomethyl propanol, other monoamines, multifunctional amines, or a combination thereof.

The copolymer is neutralized as is known. In one instance, the copolymer is neutralized by agitating the copolymer in a heated aqueous mixture containing the copolymer and the neutralization agent, thereby providing an aqueous copolymer dispersion or solution. The copolymer dispersion or solution comprises water and the reaction product of the neutralization agent and the copolymer.

An aqueous dispersion or solution is prepared comprising water and the copolymer having maleic anhydride-based repeat units and either or both of olefinic or styrenic-based repeat units; wherein at least a portion of the maleic anhydride-based repeat units are neutralized. The additive is prepared by cofeeding the aqueous dispersion or solution and the emulsion to a spray dryer to provide an additive granule. The additive can be delivered to the washing machine as a dry powder in a powder detergent formulation, or can be formulated as part of a liquid detergent. The aqueous dispersion or solution and the emulsion are preferably added at a 1:1 ratio to the spray dryer, though ratios of from 0.5:1.5 to 1.5 to 0.5 are also suitable. The composition of the additive is preferably from 20 to 40 weight percent TAED. The composition of the additive is preferably from 10 to 20 weight percent the combination of polyamine and (poly)isocyanate. The composition of the additive is preferably from 20 to 50 weight percent copolymer.

One or more compounds are optionally included as part of the additive. Compounds which decrease the water solubility of the additive are preferred. In one instance, compounds are multi-valent metal salt hydrates. Multi-valent metal salt hydrates including combinations of chloride, nitrate, sulfate, and acetate of Fe ³⁺, Al ³⁺, Ca ²⁺, Zn ²⁺, Mn ²⁺ and metal (hydr)oxide precursors which can react with carboxylic acids such as ZnO, Ca(OH)₂ are suitable. As used herein “(hydr)oxide” means either hydroxide or oxide.

Additive granules can be optionally grounded or milled into powder form to afford solid active ingredients which have a controlled or delayed releasing profile.

As described herein, the additive encapsulates, or partially encapsulates, the active. As used herein, “encapsulated” refers to the active being bound or retained within the copolymer network. As used herein, the “copolymer network” refers to the combination of the product of the interfacial polymerization reaction and the copolymer. The additives described herein are designed to release the active during a triggering event (in the context of the present disclosure, the triggering event might be use in a washing machine). When referring to the active being encapsulated, it refers to the active being retained within the copolymer network prior to the triggering event. The additives prepared according to the methods of the present disclosure have an encapsulating efficiency of 30 to 100 percent. Preferably, the additives prepared according to the methods of the present disclosure have an encapsulating efficiency of 60 to 100 percent. More preferably, the additives prepared according to the methods of the present disclosure have an encapsulating efficiency of 90 to 100 percent. As used herein, “encapsulating efficiency” refers to the percentage of prospective actives that are encapsulated in the copolymer network of the additive.

The additive described herein has a better long-term stability in aqueous systems than actives, such as TAED, alone. For example, when the additive is a detergent additive and is used in a washing machine the active is released from the copolymer, allowing the active to be available in the washing system to perform its detergent-enhancing functionality.

The methods described herein are suitable for preparing other types of solid powder systems. For example, the methods described herein can include but are not limited to encapsulating fabric softening agents, detergent actives, bleach actives, fertilizers, micronutrients, pesticides (fungicides, bactericides, insecticides, acaricides, nematocides, and the like), biocides, microbial control agents, polymeric lubricants, fire retardants, pigments, dyes, urea inhibitors, food additives, flavorings, pharmaceutical agents, tissues, antioxidants, cosmetic ingredients (fragrances, perfumes and the like), soil amendments (soil repelling agents, soil release agents and the like), catalysts, diagnostic agents and photoprotective agents (UV blockers and the like).

### EXAMPLES

The materials used in this invention and their sources are listed below:
Methylene chloride is commercially available from Sigma-Aldrich.
Atlox™ 4914, is a nonionic polymeric surfactant with a low HLB value of 6, commercially available from Croda,
PAPI 27, commercially available from the Dow Chemical Company, is a polymethylene polyphenylisocyanate that contains methylene diphenyl diisocyanate (MDI). It has an average molecular weight of 340 and an isocyanate equivalent weight of 134.0, and NCO content by weight of 31.4%.
Celvol 203 is a polyvinyl alcohol commercially from Kuraray.
TAED: commercially available from Sigma-Aldrich
Ethylenediamine is obtained from The Dow Company.
ISOBAM-110 was obtained from Kuraray. It is a copolymer of poly(maleic anhydride-alt-isobutylene) with a weight average molecular weight of 160,000. It is an ammonium salt product based on Standard type ISOBAM and is soluble in water.

### Interfacial Polymerization Procedure

Following the capsule formulation in the tables below (where the weight percent is calculated based on the final encapsulated TAED product), the Atlox 4914 surfactant and 10% TAED powder were added to the methylene chloride solvent. The mixture was mixed vigorously via a vortex mixer to form a suspension of TAED. Polyisocyanate (PAPI 27) was added to the suspension and well mixed. The mixture is used as the oil phase. The aqueous phase was prepared by adding polyvinyl alcohol to water to make a 4.5% (wt.) solution.

The aqueous phase was poured on top of the oil phase and the mixture was emulsified via a Silverson L5 high shear mixer to generate an emulsion.

Ethylenediamine (EDA) in water solution (30%) was then added and the mixture was allowed to stir at ambient temperature for at least 30 min.

TABLE 1
emulsion formulation of interfacial polymerization reaction product

| Component | Wt. (g) | Wt. % |
|---|---|---|
| Methylene Chloride | 15.13 | 35.516 |
| PAPI 27 | 0.89 | 2.089 |
| TAED | 1.80 | 4.225 |
| Atlox 4914 | 0.18 | 0.423 |
| EDA | 0.18 | 0.423 |
| Celvol 205 | 1.08 | 2.535 |
| Water | 23.34 | 54.789 |
| total | 42.60 | 100% |

### Examples 1 and 2

Two formulations, Example 1 and Example 2, are prepared using the emulsion formulation prepared according to the above. The emulsion formulation was co-fed with water solutions of sodium dodecyl sulfate and Isobam 110 as defined in Table 2 into a Fujisaki Micro Mist spray dryer at the same flow rate and spray dried to composite particles comprised of TAED capsules and surfactant. Spray drying conditions: liquid feed rate setting is 4 ml/min for each feed. The inlet temperature was set at 140° C. and the outlet temperature was equilibrated at 45-50° C. The targeted encapsulated TAED composition is listed in Table 2.

TABLE 2
Formulation of encapsulated Examples

| | |
|---|---|
| Example 1 | Example 2 |

| Components | Wt. (g) | wt % | Wt (g) | wt % |
|---|---|---|---|---|
| PAPI 27 | 1.05 | 15% | 1.05 | 12% |
| TAED | 2.11 | 31% | 2.11 | 24% |
| Atlox 4914 | 0.21 | 3% | 0.21 | 2% |
| EDA | 0.21 | 3% | 0.21 | 2% |
| Celvol 205 | 1.27 | 19% | 1.27 | 14% |
| Na dodecyl sulfate | 0.50 | 7% | 0.50 | 6% |
| Isobam 110 | 1.50 | 22% | 3.50 | 40% |
| Total | 6.85 | 100% | 8.85 | 100% |

The formulation of Example 2 is shown in Table 2. 0.5 g of encapsulated Example 2 was used for performance testing. As can be seen, the active TAED concentration is 24% (0.12 g TAED).

### Comparative Examples

Comparative example 1: 0.5 g TAED powder without any encapsulation.

Comparative example 2: 0.167 g TAED powder without any encapsulation.

Comparative example 3: 0.125 g TAED powder without any encapsulation.

Performance Testing; HPLC Analysis for Determining Hydrolysis of TAED to (DAED)

Examples 1 and 2 and Comparative Examples 1 through 3 were added to 20 g All™ Mighty Pac™ detergent in separated vials, and shaken for 10 min. At specified times, 1 droplet (ca. 0.1 g) of the mixture was added to 10 g 1:3 Acetonitrile/H2O solvent, and sonicated for 15 minutes to fully dissolve TAED solid. The concentration of DAED of the prepared samples were measured using an Agilent 1100 High-Performance Liquid Chromatography (HPLC) with quaternary pump and diode array detector. The HPLC method conditions are summarized in the table below.

TABLE 3
HPLC Testing Conditions

| | |
|---|---|
| System | Agilent 1100 with quaternary |
| | pump and diode array detector |
| Column | Eclipse XDB-C18: |
| | 4.6 mm × 50 mm × 5 μm |
| Column | 40° C. |
| Temperature | |
| Injection Volume | 1 μL sample |
| Flow Rate | 1 mL/min |
| Mobile Phases | A = 18.2 MΩ-cm water, |
| | B = acetonitrile |

Composition

| Gradient | Time (min) | % A | % B |
|---|---|---|---|
| | 0.0 | 65 | 35 |
| | 3.5 | 0 | 100 |
| | 5.5 | 0 | 100 |

| | |
|---|---|
| Equilibration Time | 2.5 min |
| Total Run Time | ~10 |
| Detection | UV (DAD) @ 216 nm, |
| | BW 4 nm, 1 cm cell (TAED) |
| | UV (DAD) @ 205 nm, |
| | BW 4 nm, 1 cm cell (DAED) |

The concentration of DAED was recorded over time, as provided in Table 4. Both Example 1 and Example 2 showed much less DAED concentration with time as compared to the Comparative Examples, indicating the improved stability of TAED toward hydrolysis in the claimed compositions. Since DAED is generated from TAED hydrolysis, the slower increase in DAED concentration indicates good encapsulation efficiency.

TABLE 4
Performance Testing Results on DAED concentration (%)

| | Initial Day | Day 2 | Day 7 | Day 20 | Day 36 |
|---|---|---|---|---|---|
| | (%) | (%) | (%) | (%) | (%) |
| Example 1 | 0 | 0.049666 | 0.145367 | 0.209239 | 0.207803 |
| Example 2 | 0 | 0.047226 | 0.123818 | 0.189211 | 0.193982 |
| Comparative | 0 | 0.050399 | 0.210765 | 0.44118 | 0.615091 |
| Example 1 | | | | | |
| Comparative | 0 | 0.048393 | 0.211279 | 0.400042 | 0.522978 |
| Example 2 | | | | | |
| Comparative | 0 | 0.047535 | 0.202895 | 0.374646 | 0.391786 |
| Example 3 | | | | | |

1. An additive comprising:
an active;
the interfacial polymerization reaction product of a (poly)isocyanate and a polyamine; and
a copolymer having maleic anhydride-based repeat units and either or both of olefinic or styrenic-based repeat units; and wherein at least a portion of the maleic anhydride-based repeat units are neutralized.

2. The additive of claim 1, wherein the (poly)isocyanate is selected from the group consisting of toluene diisocyanate, 4,4′-diphenylmethane diisocyanate, polymethylene polyphenyl isocyanate, isophorone diisocyanate, 1,4-diisocyanatobutane, 1, 4-phenylene diisocyanate, 1,3-phenylene diisocyanate, hexamethylene diisocyanate, 1,3-bis(isocyanatomethyl)benzene, 1,8-diisocyanatooctane, 4-4′-methylenebis(phenyl isocyanate), and 4,4′methylenebis(cyclohexyl isocyanate).

3. The additive of claim 1, wherein the polyamine is a water-soluble polyamine.

4. The additive of claim 3, wherein the water-soluble polyamine is selected from the group consisting of ethylenediamine, diethylenetriamine, triethylenetretraamine, tetraethylenepentamine, and pentaethylenehexamine.

5. The additive of claim 1, wherein the active comprises one or both of tetraacetylethylenediamine and triacetylethylenediamine.

6. The additive of claim 1, wherein the olefinic or styrenic-based repeat units are derived from ethylene, propylene, isobutene, octadodecene, styrene or a mixture thereof.

7. The additive of claim 1, wherein the maleic anhydride-based repeat units are neutralized with neutralization agent selected from the list consisting of potassium hydroxide, sodium hydroxide, ammonium hydroxide, monoethanolamine, diethanolamine, triethanolamine, aminomethyl propanol, other monoamines, multifunctional amines, or a combination thereof.

8. The additive of claim 1, wherein the encapsulating efficiency of the active in the additive is from 60 to 100 percent.

9. A method of preparing an additive comprising:
providing an oil phase comprising an active, a solvent, a (poly)isocyanate;
providing an aqueous phase comprising water and an emulsifier;
mixing the oil phase and the aqueous phase to provide an emulsion;
providing a polyamine to the emulsion;
providing an aqueous dispersion or solution comprising a copolymer having maleic anhydride-based repeat units and either or both of olefinic or styrenic-based repeat units;
wherein at least a portion of the maleic anhydride-based repeat units are neutralized; and
cofeeding the emulsion and the aqueous dispersion or solution to a spray dryer.

10. The method of claim 9, wherein the (poly)isocyanate is selected from the group consisting of toluene diisocyanate, 4,4′-diphenylmethane diisocyanate, polymethylene polyphenyl isocyanate, isophorone diisocyanate, 1,4-diisocyanatobutane, 1, 4-phenylene diisocyanate, 1,3-phenylene diisocyanate, hexamethylene diisocyanate, 1,3-bis(isocyanatomethyl)benzene, 1,8-diisocyanatooctane, 4-4′-methylenebis(phenyl isocyanate), and 4,4′methylenebis(cyclohexyl isocyanate).

11. The method of claim 9, wherein the polyamine is selected from the group consisting of ethylenediamine, diethylenetriamine, triethylenetretraamine, tetraethylenepentamine, and pentaethylenehexamine.

12. The method of claim 9, wherein the solvent has a water solubility of 10 grams per 100 milliliters or less.

13. The method of claim 9, wherein the active is one or both of tetraacetylethylenediamine or triacetylethylenediamine.

14. The method of claim 9, wherein the olefinic or styrenic-based repeat units are derived from ethylene, propylene, isobutene, octadodecene, styrene or a mixture thereof.

15. The method of claim 9, wherein the maleic anhydride-based repeat units are neutralized with neutralization agent selected from the list consisting of potassium hydroxide, sodium hydroxide, ammonium hydroxide, monoethanolamine, diethanolamine, triethanolamine, aminomethyl propanol, other monoamines, multifunctional amines, or a combination thereof.
